(19) United States
(12) Patent Application Publication
(10) Pub. No.: US 2008/0103613 A1
(43) Pub. Date: May 1, 2008

(54) Level Control Device, In Particular For Controlling Members Of A Motor Vehicle

(75) Inventors: Stephane Vanhelle, Marignier (FR); Patrice Laurent, Viuz en Sallaz (FR); Laurent Mounier, Annemasse (FR); Guy Razurel, Villy le Pelloux (FR); Gilles Pittion, Sciez (FR); Xavier Drounin, Annemasse (FR); Maurice Rastoldo, Fillinges (FR)

Correspondence Address: OSHA LIANG L.L.P., 1221 MCKINNEY STREET, SUITE 2800, HOUSTON, TX, 77010, US

(73) Assignee: DAV Societe Anonyme, Creteil (FR)

(21) Appl. No.: 11/663,685

(22) PCT Filed: Sep. 5, 2005
(86) PCT No.: PCT/EP05/54352

§ 371 Date: Mar. 23, 2007

(30) Foreign Application Priority Data
Sep. 24, 2004 (FR) 0410144

(51) Int. Cl. G05G 9/047

(52) U.S. Cl. 700/90

(57) ABSTRACT

The invention concerns a control device comprising a lever (12), having a globally circular shape about an axis of revolution (Z), articulated on a fixed support (14) and provided with a maneuvering proximale end (16). It also comprises an electrode (24) for detecting proximity of a user's hand relative to the end (16) for maneuvering the lever (12), and means (28) for electrically connecting said electrode (24) with a fixed electric circuit (26) borne by the support (14). The electrically connecting means (28) comprise an annular deformable conductive member (50) enclosing the lever (12) so as to contribute in masking said lever (12).

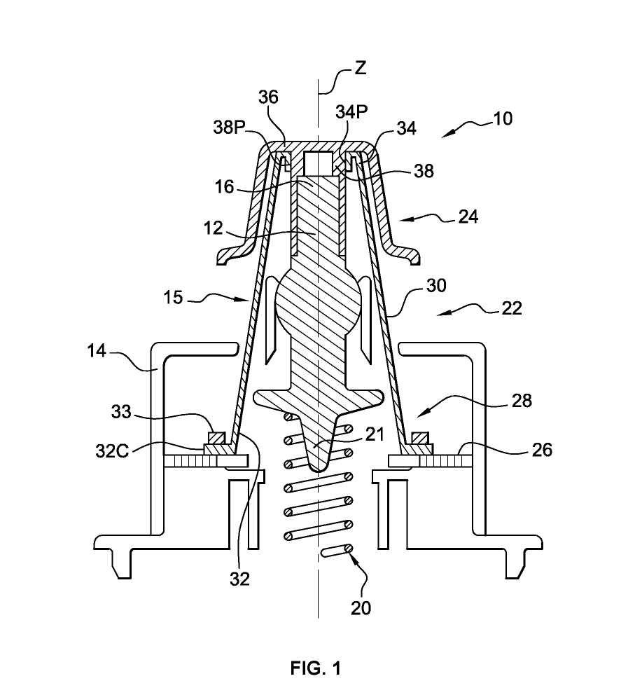

The present invention relates to a lever control device, in particular for controlling the elements of a motor vehicle.

A control device is already known in the prior art in particular from EP-A-1 256 038, of the type comprising:
a lever, having a general form of revolution about an axis of revolution, articulated on a fixed support and provided with a proximal maneuvering end,
an electrode for detecting the proximity of the hand of the user in relation to the maneuvering end of the lever, and
means for connecting this electrode electrically with a fixed electric circuit carried by the support.

It is desired to use a control device of this type for controlling one or more elements of the motor vehicle.

Usually, the lever can be moved with various movements corresponding to various degrees of freedom of the lever. These movements of the lever performed for selecting an element or a function to be activated. Other movements of the lever are carried out in order to activate the element or the selected function.

The proximity detecting electrode can make it possible to optimize comfort when the control device is used, by placing this control device in a predetermined configuration (illumination of a zone of an instrument panel, pre-selection of a data display screen, etc.), this as soon as the user's hand approaches the lever.

The proximity detecting electrode can moreover make it possible to influence the activation of an element or of a function in the presence of the user's hand in the proximity of, or in contact with, the maneuvering end of the lever. In this way, the risk of accidentally activating the element or function is prevented.

The hand of the user and the detecting electrode are similar to the plates of an electric capacitor of which the capacity varies when the hand approaches the electrode. Proximity to or contact with the hand is therefore detected by measuring a variation of this capacity by suitable measuring means.

Means for measuring the variation in capacity normally comprise an electric circuit fixed with respect to the support. The detecting electrode is connected electrically to this electric circuit with the aid of electrical connecting means which are generally relatively complex. Indeed, these connecting means must connect the support which is fixed to the lever which it moveable with several degrees of freedom.

In addition, the control device of the aforementioned type includes means for at least partially masking the lever, participating in the aesthetics of the control device and the protection of the mechanical or electrical connecting means between the moveable lever and the fixed support on which this lever is articulated.

The object of the invention is in particular to simplify the structure of the electrical connecting means.

To this end, the subject of the invention is a control device of the aforementioned type, characterized in that the electrical connecting means comprise a deformable annular conductive element surrounding the lever so as to participate in masking this lever.

This annular element provides at the same time the functions of masking the lever and of forming the electrical connection, which simplifies the structure of the control device according to the invention. In addition, the annular organ is easy to arrange around the lever.

A control device according to the invention can additionally include one or more of the following features:
the annular element is secured to the fixed support;
the annular element is provided with a distal end comprising positioning means cooperating by complementary forms with complementary positioning means provided on the fixed support;
the annular element is provided with a proximal end surrounding the proximal maneuvering end of the lever and forming at least one first part of the detecting electrodes;
the lever is moveable in rotation about its axis of revolution, the proximal end of the annular element being in sliding electrical contact with a second part of the detecting electrode secured to the proximal maneuvering end of the lever;
a conductive lubricant, for example filled with carbon or copper particles, is positioned between complementary bearing surfaces provided on the proximal end of the annular element and the second part of the detecting electrode;
the proximal end of the annular element grips an axial journal of the second part of the detecting electrode;
the second part of the detecting electrode has a general form of revolution and surrounds the first part of the detecting electrode;
the annular element is made of an elastically deformable material, in particular an electrically conductive polymer, for example made of elastomer filled with carbon particles;
the annular element is arranged in compression between the fixed support and the second part of the detecting electrode, so as to return the proximal end of the annular element into electrical contact with the second part of the detecting electrode;
the annular element has a truncated conical form converging towards the proximal maneuvering end of the lever;
the lever can be moved with degrees of freedom chosen from a translational movement parallel to its axis of revolution and pivoting movements around axes perpendicular to its axis of revolution.

The invention will be better understood on reading the following description, given solely by way of example and made with reference to the single FIGURE which is a view in axial section of a control device according to an embodiment of the invention.

A control device according to the invention, indicated by the general reference 10, has been shown in the single FIGURE.

In the example described, the control device is used to control one or more elements of a motor vehicle, for example for selecting functions on a data display screen and for activating these functions.

The control device 10 comprises a lever 12, with a general form of revolution about an axis Z. This lever 12 is articulated on a fixed support 14 with the aid of means of articulation 15.

The lever 12 is provided with a proximal end 16 for maneuvering this lever 12.

The means of articulation 15 are of the ball joint type.

These means of articulation 15 enable the lever 12 to rotate in relation to the support 14, about the axis Z, and permit pivoting movements of the lever 12 in relation to the support 14 about at least two axes perpendicular to each other and to the axis of revolution Z.

The means of articulation 15 moreover permit a translational movement of the lever 12 parallel to its axis of revolution Z. To this end, the lever 12 is provided, at its distal end, with a guiding finger 21. Elastic means 20 are provided for returning the lever 12 to a rest position.

The control device 10 additionally includes means 22 for detecting the proximity of the hand of a user in relation to the maneuvering end 16 of the lever 12. These means of detection 22 comprise in particular a detecting electrode 24 and a printed circuit board carried by the support 14. This board forms an electrical circuit 26. The detecting electrode 24 is electrically connected to the electric circuit 26 by electrical connecting means 28.

These electrical connecting means 28 comprise a conductive annular element 30, with a generally truncated conical form converging towards the proximal maneuvering end 16 of the lever 12. This truncated conical form is advantageous since it makes it possible to have a small frictional surface in the region of the upper part of the lever 12.

The annular element 30 surrounds the lever 12 so as to participate in masking this lever 12.

It will be noted that the motor vehicle generally has means for illuminating elements provided close to the device 10, for example means for illuminating the instrument panel or means for illuminating the elements controlled by the device 10. The annular element 30 is preferably made of an opaque material so as to prevent the undesirable escape of light emitted by the illuminating means arranged behind the support 14.

In addition, the annular element 30 is generally made of an elastically deformable material so as not to impede the movements of the lever 12 with respect to the support 14. Preferably, the annular element 30 is made of an electrically conductive deformable polymer, for example an elastomer filled with carbon particles.

The annular element 30, secured to the fixed support 14, is positioned on this support 14 with the aid of conventional positioning means (not shown) provided on a distal end 32 of the element 30, cooperating by means of complementary forms with the complementary positioning means provided on the electrical circuit 26.

Preferably, the device includes a fixing element 33 intended to maintain the annular element 30 on the fixed support 14 by gripping a collar 32C of the distal end 32 between this fixing element 33 and the electrical circuit 26.

In addition, the annular element 30 is provided with a proximal end 34 forming a first part of the detecting electrode 24. This first part 34 surrounds the proximal end 16 of the lever 12.

The detecting element 24 has a second part 36, having the general form of a cap of revolution, surrounding the first part 34 of the detecting electrode 24.

The second part 36 of the electrode 24 may be metallic or made of a plastic covered with a metallic layer.

The second part 36 is provided with an axial journal 38 secured to the proximal maneuvering end 16 of the lever 12. This axial journal 38 is gripped by the proximal end 34 of the annular element 30.

The proximal end 34 of the annular element 30 is in sliding electrical contact with the second part 36 of the detecting electrode 24, so as to permit rotation with respect to the support 14 of this second part 36 and of the lever 12 about the axis Z.

Preferably, a conductive lubricant, for example one filled with carbon or copper particles, is disposed between the complementary bearing surfaces 34P, 38P provided on the proximal end 34 of the annular element 30 and the second part 36 of the detecting electrode 24, more particularly the journal 38. Thus, friction between the annular element 30 and the second part 36 of the electrode 24 is reduced during their relative rotation.

Also preferably, the areas of the complementary bearing surfaces 34P, 38P are limited so as to limit the resisting torque generated by friction between these surfaces when the lever 12 is in rotation in relation to the support 14 about its axis of revolution Z.

It will be noted that the annular element 30 is arranged in compression between the fixed support 14 and the second part 36 of the detecting electrode 24, so as to return the proximal end 34 of the annular element 30 into electrical contact with the second part 36 of the detecting electrode 24. This arrangement in compression moreover ensures that the annular element 30 is held on the fixed support 14, in particular during pivoting movements of the lever 12 about axes perpendicular to the axis of revolution Z and during translational movements of this lever 12 parallel to this axis of revolution Z.

The invention is not limited to the embodiment described above.

In particular, the lever 12 could be made moveable in any degree of freedom chosen from a translational movement parallel to its axis of revolution Z and pivoting movements about axes perpendicular to its axis of revolution z.

Among the advantages of the invention, the following will be noted.

The electrical connection between the annular element 30 and the fixed support 14 can be provided without soldering. Mounting the control device 10 is simplified in this way.

The annular element 30 surrounding the lever 12, makes it possible to protect this lever 12 and other elements of the device 10, such as mechanical or electrical connecting means between the moveable lever and the fixed support, against the intrusion of foreign bodies, (dust, liquids, etc.)

1. A control device of the type comprising:
a lever, having a general form of revolution about an axis of revolution (Z), articulated on a fixed support and provided with a proximal maneuvering end,
an electrode for detecting the proximity of the hand of the user in relation to the maneuvering end of the lever, and
means for connecting this electrode electrically with a fixed electric circuit carried by the support,
wherein the electrical connecting means comprise a deformable annular conductive element surrounding the lever so as to participate in masking this lever.

2. The control device as claimed in claim 1, wherein the annular element is secured to the fixed support. The control device as claimed in claim 2, wherein the annular element is provided with a distal end comprising positioning means cooperating by complementary forms with complimentary positioning means provided on the fixed support.

3. The control device as claimed in claim 2, wherein the annular element is provided with a distal end comprising positioning means cooperating by complementary forms with complementary positioning means provided on the fixed support.

4. The control device as claimed in claim 2, wherein the annular element is provided with a proximal end surrounding the proximal maneuvering end of the lever and forming at least one first part of the detecting electrode.

5. The control device as claimed in claim 4, wherein the lever is moveable in rotation about its axis of revolution (Z), the proximal end of the annular element being in sliding electrical contact with a second part of the detecting electrode secured to the proximal maneuvering end of the lever.

6. The control device as claimed in claim 5, wherein a conductive lubricant, for example filled with carbon or copper particles, is positioned between complementary bearing surfaces provided on the proximal end of the annular element and the second part of the detecting electrode.

7. The control device as claimed in claim 5, wherein the proximal end of the annular element grips an axial journal of the second part of the detecting electrode.

8. The control device as claimed in claim 5, wherein the second part of the detecting electrode has a general form of revolution and surrounds the first part of the detecting electrode.

9. The control device as claimed in claim 5, wherein the annular element is made of an elastically deformable material, in particular, an electrically conductive polymer, for example made of elastomer filled with carbon particles.

10. The control device as claimed in claim 9 wherein the annular element is arranged in compression between the fixed support and the second part of the detecting electrode, so as to return the proximal end of the annular element into electrical contact with the second part of the detecting electrode.

11. The control device as claimed in claim 1, wherein the annular element has a truncated conical form converging towards the proximal maneuvering end of the lever.

12. The control device as claimed in claim 1, wherein the lever is moveable with degrees of freedom chosen from a translational movement parallel to its axis of revolution (Z) and pivoting movements around axes perpendicular to its axis of revolution (Z).
